(19) United States
(12) Patent Application Publication
(10) Pub. No.: US 2007/0091821 A1
(43) Pub. Date: Apr. 26, 2007

(54) Address management and routing methods for wireless personal area network (WPAN)

(75) Inventors: Eun-ill Seo, Suwon-si (KR); Jin-young Yang, Seoul (KR); Chun-hui Zhu, New York, NY (US)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/580,897

(22) Filed: Oct. 16, 2006

Related U.S. Application Data
(60) Provisional application No. 60/729,730, filed on Oct. 25, 2005.

(30) Foreign Application Priority Data
Jun. 28, 2006 (KR) 10-2006-0058657

(51) Int. Cl. H04L 12/28; H04L 12/56

(52) U.S. Cl. 370/254; 370/400

(57) ABSTRACT

An address management method and a routing method for a wireless personal area network (WPAN) is provided. The address management method includes setting an update route flag relating to a portable node and a previous network address which is an address of the node before the movement, if a node moves around; and broadcasting a network command frame including the set update route flag and previous network address.

### CROSS-REFERENCE TO RELATED APPLICATIONS

This application claims priority from U.S. Provisional Patent Application No. 60/729,730 filed on Oct. 25, 2005, in the United States Patent and Trademark Office, and from Korean Patent Application No. 10-2006-0058657 filed on Jun. 28, 2006 in the Korean Intellectual Property Office, the disclosure of which is incorporated herein by reference.

### BACKGROUND OF THE INVENTION

1. Field of the Invention

Methods consistent with the present invention relate to address management and routing for a wireless personal area network (WPAN). More particularly, the present invention relates to address management and routing for a WPAN which utilizes an address of a portable node before the movement and an update route flag.

2. Description of the Related Art

In contrast to a local area network (LAN) or a wide area network (WAN) that are widely known technologies, a personal area network (PAN) is a network owned by an individual person. That is, devices owned by the individual person are interconnected to construct the network in order to provide convenience for the individual person. A wireless PAN (WPAN) is an implementation of the PAN in wireless connection.

In such a WPAN, nodes constructing the network are mobile. For doing so, it is necessary to process the data transfer to a moved node.

FIG. 1 illustrates a related address management method according to a node movement in a WPAN. In FIG. 1, a node A is designated to a portable node.

Referring to FIG. 1, when the node A moves and newly accesses a node B, the node A transmits a registration request message to a coordinator C. Herein, the registration request message contains information relating to an address assigned from a parent node B which is accessed due to the movement of the node A.

Upon receiving the registration request message, the coordinator C transmits a registration response message to the node A in reply to the registration request message. The registration response message contains an address which is newly assigned to the node A by the coordinator C. Accordingly, the coordinator C is able to update the new address of the node A.

However, when a node moves around, the related address management method in the WPAN should transmit and receive the registration request message and the registration response message between the portable node A and the coordinator C. The more portable nodes, the more overhead on the coordinator C. As a result, as the number of portable nodes increases, the coordinator C suffers serious overhead.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention has been provided to address the above-mentioned and other problems and disadvantages occurring in the related arrangement. An aspect of the present invention is to provide an address management method and a routing method for a WPAN, which updates an address of a portable node and provides a route to the portable node by use of a node address before the movement and an update route flag.

According to an aspect of the present invention, there is provided an address management method including setting an update route flag relating to a portable node and a previous network address which is an address of the node before the movement, if a node moves around; and broadcasting a network command frame including the set update route flag and previous network address.

The update route flag may be carried in a frame control field which is included in the network command frame.

The update route flag may occupy part of a reserved area of the frame control field.

The setting operation may set the update route flag to discriminate from the node before the movement so as to indicate the movement of the node when the node moves around.

The setting operation may set the update route flag to “1” or “TRUE” to indicate the movement of the node when the node moves around, and set the update route flag to “0” or “FALSE” when the node does not move.

The network command frame may include the frame control field containing the update route flag, a routing field containing an address of the portable node, and a route_update message containing a previous network address of the portable node.

According to an aspect of the present invention, a routing method includes receiving a network command frame which includes an update route flag indicating whether a node moves around or not and a previous network address which is an address of the node before the movement; checking whether there is the previous network address included in the network command frame is in a routing table; and updating the routing table based on a result of the checking.

The updating operation may be carried out by updating the previous network address to an address of the portable node, which is an address after the movement of the node, as contained in the network command frame and establishing a route to the portable node when the previous network address is in the routing table according to a result of the checking.

The updating operation may delete a route relating to the previous network address defined in the routing table when the previous network address is in the routing table according to a result of the checking.

The routing method may further include sending a route reply (RREP) message to the portable node when the previous network address is in the routing table.

The routing method may further include determining whether the update route flag is set to discriminate the movement of the node; and sending a RREP message to the portable node when it is determined that the update route flag is set to a portable node to which the node moves at the determining operation.

The determining operation may determine that the node is set to a portable node when the update route flag is set to “1” or “TRUE”.

The network command frame may be received, which includes a frame control field containing the update route flag, a routing field containing an address of the portable node, and a route_update message containing the previous network address of the portable node.

According to another aspect of the present invention, an address management method includes setting an update route flag relating to a portable node when a node moves around; and broadcasting a packet including the update route flag and a previous network address which is an address of the node before the movement.

The update route flag may occupy part of a reserved area of the frame control field included in the packet.

The update route flag may be set to discriminate from the node before the movement so as to indicate the movement of the node when the node moves around.

The update route flag may be set to “1” or “TRUE” to indicate the movement of the node when the node moves around, and set to “0” or “FALSE” when the node does not move.

The packet may include at least one of the frame control field containing the update route flag, an announce message containing an address of the portable node, and the previous network address of the portable node.

According to another aspect of the present invention, a routing method includes receiving a packet which includes a update route flag indicating movement of a node and a previous network address which is an address of the node before the movement; determining whether the node moves around based on the update route flag included in the packet; checking whether the previous network address is in a routing table; and updating the previous network address based on a result of the determination and establishing a route to the portable node based on a result of the checking.

The determining operation may determine that the node moves around when the update route flag is set to “1” or “TRUE”, and the setting operation may update the previous network address to an address of the portable node, which is an address of the node after the movement when it is determined that the node is the portable node.

The setting operation may establish a route to the portable node when it is checked that the previous network address is in the routing table at the checking operation.

The address management method may further include sending a reply message, which is an End_Device_Route_Update message, in response to the received packet.

### BRIEF DESCRIPTION OF THE DRAWING FIGURES

The above and other aspects of the present invention will become more apparent and more readily appreciated from the following description of exemplary embodiments thereof, with reference to the accompanying drawings, in which:

FIG. 1 is a diagram for illustrating a related address management method according to a node movement in a WPAN;

FIG. 2 is a flowchart for outlining an address management method in a PAN according to an exemplary embodiment of the present invention;

FIGS. 3A and 3B are diagrams for illustrating exemplary announce message End_Device_Annce and frame control field that are used for the address management and the routing according to an exemplary embodiment of the present invention;

FIG. 4 is a flowchart for outlining an address management method in a PAN according to an exemplary embodiment of the present invention; and

FIGS. 5A and 5B are diagrams for illustrating an exemplary network command frame and route update message that is used for the address management and the routing according to an exemplary embodiment of the present invention.

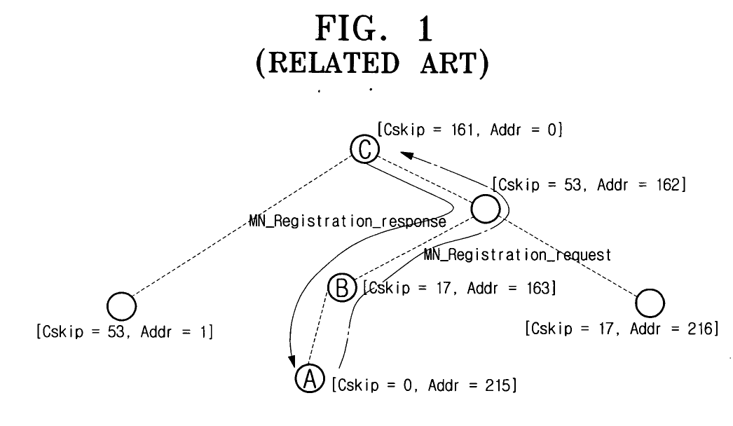

### DETAILED DESCRIPTION OF THE EXEMPLARY EMBODIMENTS

Certain exemplary embodiments of the present invention will now be described in greater detail with reference to the accompanying drawings.

In the following description, the same drawing reference numerals are used to refer to the same elements, even in different drawings. The matters defined in the following description, such as detailed construction and element descriptions, are provided as examples to assist in a comprehensive understanding of the invention. Also, well-known functions or constructions are not described in detail, since they would obscure the invention in unnecessary detail.

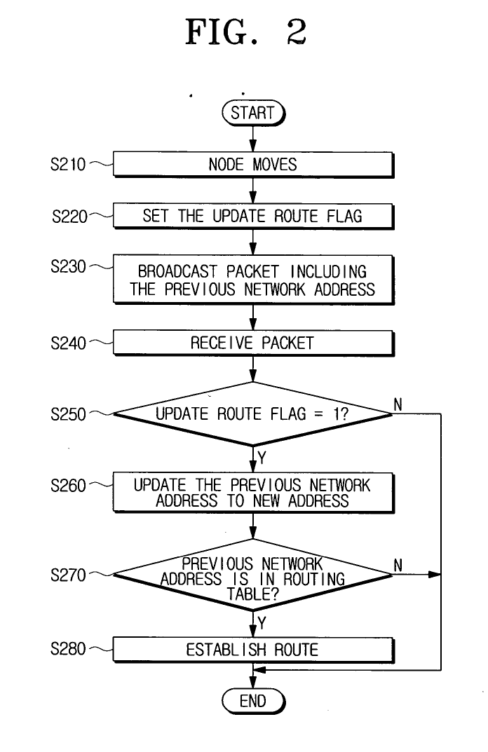

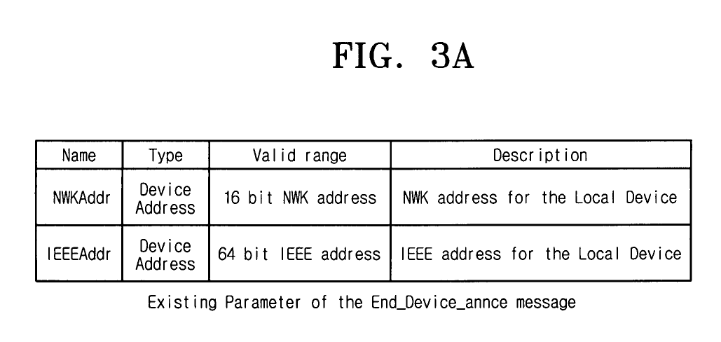

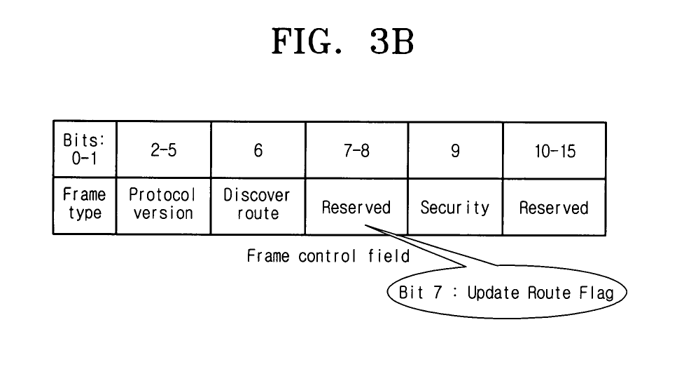

FIG. 2 is a flowchart for outlining an address management method in a PAN according to an exemplary embodiment of the present invention, and FIGS. 3A and 3B are diagrams for illustrating an exemplary announce message End_Device_Annce and frame control field that is used for the address management and the routing according to an exemplary embodiment of the present invention.

To ease the understanding of the invention, descriptions will be made on an address updating method for a portable node and a route updating method to the portable node when one of nodes constructing a PAN moves around.

Referring first to FIGS. 2, 3A and 3B, when one of nodes constructing the network moves around (S210), a portable node sets an update route flag included in a frame control field (S220).

Specifically, the portable node sets the update route flag to be discriminated before the movement. A good example of the update route flag setting is “1/0” or “TRUE/FALSE”. The update route flag occupies part of a reserved area in the frame control field as shown in FIG. 3B.

Next, the portable node broadcasts a packet together with a previous network address PrevNWKAddr which is the node address before the movement (S230).

The broadcast packet is generated using an announce message End_Device_Annce, a frame control field, and a previous network address PrevNWKAddr as shown in FIGS. 3A and 3B. The portable node broadcasts the generated packet over the network. A new address and a device address with respect to the moved location of the portable node are contained in the announce message. Herein, the new address is defined using 16-bit addressing architecture, and the device address is defined using 64-bit IEEE addressing architecture.

Each node in the network receives the broadcast packet sent by the portable node (S240).

Each node which receives the broadcast packet, determines whether the update route flag contained in the packet sent by the portable node is set to “1” (S250).

When the update route flag is set to “1”, each receiving node updates its address MAP table in reference to the previous network address and the device address of the portable node, that are contained in the packet (S260). In other words, each receiving node updates the previous network address for the portable node to a new address in its address MAP table.

Next, each receiving node checks whether there is the previous network address of the received packet in its routing table (S270).

When the previous network address is found in the routing table, each receiving node establishes a route to the portable node using the information contained in the received packet (S280). At this time, the nodes having the previous network address in their routing tables can transmit a response message End_Device_Route_Update to the portable node in reply to the announce message. Thus, even after the node's movement, not only the data can be transferred to the portable node, not to the node address before the movement, but also it is possible to process the address updating of the portable node and the route updating between the receiving node and the portable node at the same time.

By contrast, in the address management and routing methods according to an exemplary embodiment of the present invention, when the update route flag is set to “0” at the operation S250, the receiving node checks whether the address of the portable node, which is contained in the received packet, is in its routing table. When there is no address of the portable node in the routing table, the receiving node establishes a route to the portable node using the information contained in the received packet.

So far, descriptions have explained the address management and routing methods according to an exemplary embodiment of the present invention, particularly, the address updating method of the portable node and the route updating method to the portable node based on the announce message End_Device_Annce, the frame control field, and the packet generated using the previous network address.

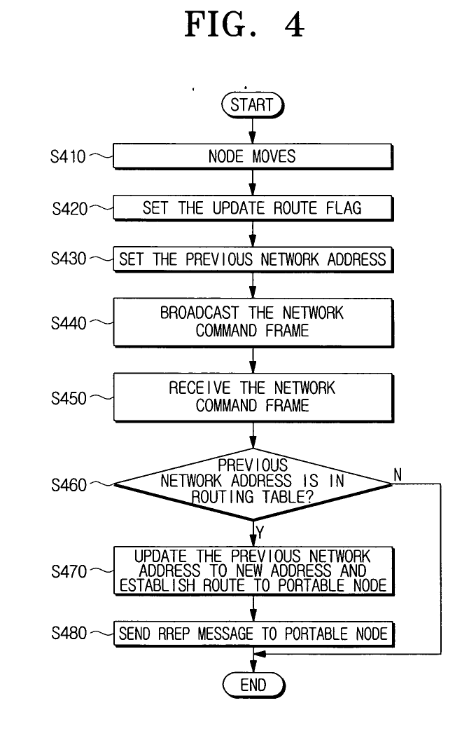

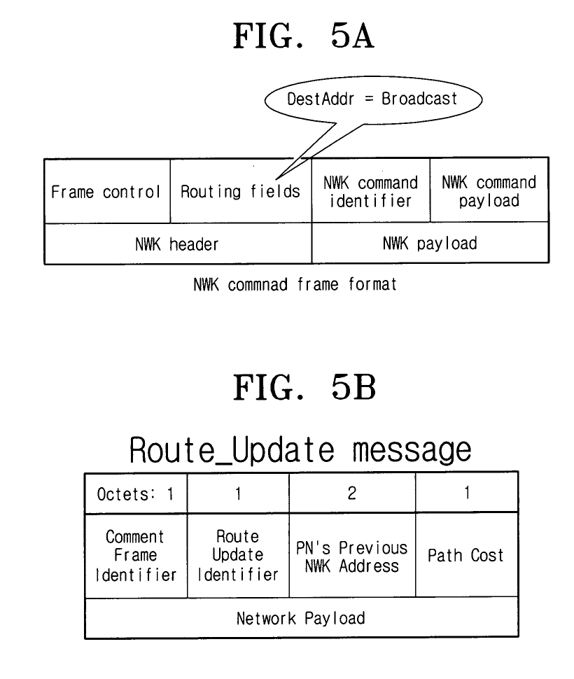

Hereafter, address management and routing methods in a PAN are illustrated according to another exemplary embodiment of the present invention in reference to FIGS. 4, 5A and 5B.

FIG. 4 is a flowchart for outlining the address management method in the PAN according to another exemplary embodiment of the present invention, and FIGS. 5A and 5B are diagrams showing exemplary network command frame and update route message that are used for the address management and the routing according to another exemplary embodiment of the present invention.

Referring now to FIGS. 4, 5A and 5B, when one of nodes constructing the network moves around (S410), the portable node sets an update route flag included in the frame control field (S420). An example of the update route flag setting may be “1/0” or “TRUE/FALSE”.

Next, the portable node sets a previous network address PrevNWKAddr which is an address before the movement (S430). In more detail, the portable node sets the previous network address included in a route_update message as shown in FIG. 5B. For instance, when the previous network address of the portable node is “215”, the portable node sets the previous network address to “215”.

The route_update message, as shown in FIG. 5B, is contained in a network payload of FIG. 5A. A comment frame identifier of FIG. 5B corresponds to a network command identifier of FIG. 5A. Components of the route_update message, other than the comment frame identifier, correspond to a network command payload of FIG. 5A.

The portable node broadcasts the network command frame over the network (S440).

More specifically, the portable node broadcasts the network command frame consisting of the route_update message in which the previous network address of the portable node is set at the operation S430, the frame control field in which the update route flag is set at the operation S420, and so on.

Next, each node constructing the network receives the broadcast network command frame (S450).

The receiving node checks whether there is the previous network address PrevNWKAddr of the portable node, which is contained in the received network command frame, in its routing table (S460).

Specifically, the receiving node checks whether the previous network address of the portable node is set from the route_update message included in the network command frame. When the previous network address is set, the receiving node checks whether its routing table has the previous network address of the portable node.

When its routing table has the previous network address of the portable node, the receiving node updates the previous network address of the routable table to a new address of the moved portable node and establishes a route to the portable node (S470). At this time, the receiving node deletes the route information relating to the previous network address of the portable node.

The receiving node, which has checked the presence of the previous network address in the routing table, sends a route reply (RREP) message to the potable node (S480). Accordingly, the portable node can acquire the route to the receiving node as well.

In the address management method and the routing method according to another exemplary embodiment of the present invention, the receiving node checks whether the update route flag of the portable node is set from the frame control field included in the receiving network command frame, and sends the RREP message to the portable node when the update route flag is set to “1” or “TRUE”. Hence, the portable node can acquire the route to every node in the network.

Even when the previous network address of the portable node is not in the routing table of the receiving node at the operation S460, if the update route flag is set to “1”, the portable node can establish the route to the receiving node as the receiving node sends the RREP message to the portable node.

Meanwhile, in the address management method and the routing method according to another exemplary embodiment of the present invention, although it has been described only when one of the nodes constructing the PAN moves around to facilitate the understanding, the broadcasting method is applicable in case that a plurality of nodes of the PAN nodes moves around.

In addition, in the address management method and the routing method according to another exemplary embodiment of the present invention, the portable node is able to establish routes between the portable node and the network nodes using the received routing information by transmitting a one-hop broadcast data message which requests routing information to one-hop nodes of the portable node.

Although the address management method and the routing method according to the exemplary embodiments of the present invention have been clarified, the address management method and the routing method of the present invention are applicable to all other wireless networks.

As set forth above, by receiving the broadcast packet or network command frame including the update route flag and the previous network address of the portable node, every node constructing the network can carry out the address updating of the portable node and the route updating to the portable node at the same time.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An address management method comprising:
setting an update route flag relating to a portable node and a previous network address, which is an address of the node before the movement, when a node moves around; and
broadcasting a network command frame including the set update route flag and previous network address.

2. The address management method as in claim 1, wherein the update route flag is carried in a frame control field which is included in the network command frame.

3. The address management method as in claim 2, wherein the update route flag occupies part of a reserved area of the frame control field.

4. The address management method as in claim 1, wherein the setting sets the update route flag to discriminate from the node before the movement so as to indicate the movement of the node when the node moves around.

5. The address management method as in claim 4, wherein the setting sets the update route flag to “1” or “TRUE” to indicate the movement of the node when the node moves around, and sets the update route flag to “0” or “FALSE” when the node does not move.

6. The address management method as in claim 1, wherein the network command frame includes the frame control field containing the update route flag, a routing field containing an address of the portable node, and a route_update message containing a previous network address of the portable node.

7. A routing method comprising:
receiving a network command frame which includes an update route flag indicating whether a node moves around or not, and a previous network address which is an address of the node before the movement;
checking if the previous network address included in the network command frame is in a routing table; and
updating the routing table based on a result of the checking.

8. The routing method as in claim 7, wherein the updating is carried out by updating the previous network address to a new address of the portable node as contained in the network command frame and establishing a route to the portable node when the previous network address is in the routing table according to a result of the checking.

9. The routing method as in claim 8, wherein the updating deletes a route relating to the previous network address defined in the routing table when the previous network address is in the routing table according to a result of the checking.

10. The routing method as in claim 7, further comprising:
sending a route reply (RREP) message to the portable node when the previous network address is in the routing table.

11. The routing method as in claim 7, further comprising:
determining whether the update route flag is set to discriminate the movement of the node; and
sending a RREP message to the portable node when it is determined that the update route flag is set to a portable node to which the node moves at the determining operation.

12. The routing method as in claim 11, wherein the determining determines that the node is a portable node if the update route flag is set to “1” or “TRUE”.

13. The routing method as in claim 7, wherein the received network command frame comprises a frame control field containing the update route flag, a routing field containing an address of the portable node, and a route_update message containing the previous network address of the portable node.

14. An address management method comprising:
setting an update route flag relating to a portable node when a node moves around; and
broadcasting a packet including the update route flag and a previous network address, which is an address of the node before the movement.

15. The address management method as in claim 14, wherein the update route flag occupies part of a reserved area of a frame control field included in the packet.

16. The address management method as in claim 14, wherein the update route flag is set to discriminate from the node before the movement so as to indicate the movement of the node when the node moves around.

17. The address management method as in claim 16, wherein the update route flag is set to “1” or “TRUE” to indicate the movement of the node when the node moves around, and set to “0” or “FALSE” when the node does not move.

18. The address management method as in claim 14, wherein the packet includes at least one of a frame control field containing the update route flag, an announce message containing an address of the portable node, and the previous network address of the portable node.

19. A routing method comprising:
receiving a packet which comprises an update route flag indicating movement of a node, and a previous network address, which is an address of the node before the movement;
determining whether the node moves around based on the update route flag included in the packet;
checking whether the previous network address is in a routing table; and
updating the previous network address based on a result of the determination and establishing a route to the portable node based on a result of the checking.

20. The routing method as in claim 19, wherein the determining determines that the node moves around when the update route flag is set to “1” or “TRUE”, and
the setting updates the previous network address to an address of the portable node, which is an address of the node after the movement when it is determined that the node is the portable node.

21. The address management method as in claim 19, wherein the setting establishes a route to the portable node when it is checked that the previous network address is in the routing table at the checking operation.

22. The address management method as in claim 19, further comprising:
sending a reply message, which is an End_Device_Route_Update message, in response to the received packet.
